(19) United States
(12) Patent Application Publication
(10) Pub. No.: US 2007/0088109 A1
(43) Pub. Date: Apr. 19, 2007

(54) Near infrared ray absorption film for filter of plasma display panel

(76) Inventors: Sang Hyun Park, Daejeon Metropolitan City (KR); Su Rim Lee, Daejeon Metropolitan City (KR); Jung Doo Kim, Daejeon Metropolitan City (KR); In Seok Hwang, Daejeon Metropolitan City (KR); Kyoung Hoon Kim, Daejeon Metropolitan City (KR); Jong Chan Kim, Daejeon Metropolitan City (KR)

Correspondence Address: Song K. Jung;MCKENNA LONG & ALDRIDGE LLP, 1900 K Street, N.W., Washington, DC, 20006, US

(21) Appl. No.: 11/581,477

(22) Filed: Oct. 17, 2006

(30) Foreign Application Priority Data
Oct. 17, 2005 (KR) 2005-0097348

(51) Int. Cl. C08K 5/00

(52) U.S. Cl. 524/236

(57) ABSTRACT

Disclosed is a near infrared ray absorption film for a plasma display panel filter that includes a diimmonium-based compound and a binder resin and a plasma display panel filter and a plasma display panel having the same. The diimmonium-based compound includes substituted amine groups which are bonded to benzene rings so that charge distributions of the benzene rings are -0.104 or more.

### TECHNICAL FIELD

The present invention relates to a near infrared ray absorption film for a plasma display panel filter. More particularly, the present invention relates to a near infrared ray absorption film for a plasma display panel filter that includes a diimmonium-based near infrared ray absorption coloring material.

This application claims the benefit of the filing date of Korean Patent Application No. 10-2005-0097348, filed on Oct. 17, 2005, in the Korean Intellectual Property Office, the disclosure of which is incorporated herein in its entirety by reference.

### BACKGROUND ART

A plasma display panel assembly is formed through the following procedure. A partition is formed on a lower plate, red, green, and blue fluorescent layers are formed in grooves of the partition, an upper plate overlaps the lower plate so that an electrode of the lower plate is disposed parallel to an electrode of the upper plate while the electrodes face each other, and a discharge gas such as Ne, Ar, and Xe is filled. The plasma display panel is a next-generation display where plasma is generated when voltage is applied to an anode and a cathode to discharge gas; ultraviolet rays that are radiated from such plasma collide with fluorescent bodies to generate rays; and such rays are combined to provide an image.

However, the plasma display panel is problematic in that since an electrode is provided on an entire surface of a front glass to provide a signal and an electric source, a larger amount of electromagnetic wave is generated during the driving as compared to other displays. Additionally, near infrared rays are generated, causing the malfunction of remote controls, infrared communication ports and the like where rays in the corresponding near infrared ray range are used during communication. The near infrared wave that is generated from Xe used in a plasma display module is shown in FIG. 1. Additionally, after the discharge gas such as Ne, Ar, and Xe is filled, luminescence of three primary colors is realized by means of vacuum ultraviolet rays using red, blue, and green fluorescent bodies. Accordingly, there is a problem in that it is impossible to obtain apparent red colors due to luminescence of neon orange light in the vicinity of 590 nm when a neon atom is excited and then returns to a base state.

To avoid the above-mentioned problems of the plasma display panel, a technology where a plasma display panel filter (PDP filter) is provided on a front side of the panel has been used. Typically, the PDP filter transmits visible rays of R, G, and B therethrough, and blocks the neon wavelength of 590 nm corresponding to the orange color reducing resolution of the screen, and electromagnetic waves and near infrared rays of the wavelength of 800 to 1000 nm.

The PDP filter may have a structure where a plurality of films, for example, an antireflection film (AR film), a near infrared ray absorption layer (NIR film), a neon cut layer (a color control layer including a neon cut film), and an electromagnetic wave blocking film (EMI film) are layered. Additionally, the near infrared ray absorption film and the neon cut film may have a structure where a color control dye is added to a polymer resin in addition to a near infrared ray absorption dye and a neon cut dye, respectively, and the resulting polymer resin is applied on a transparent base.

It is preferable that the near infrared ray absorption film (NIR film) have fair durability in a high temperature condition or in a high temperature and humidity condition, high absorption of the near infrared ray having the wavelength of 800 to 1,200 nm, particularly 820 to 1,000 nm, and high transmissivity of the visible ray having the wavelength of 400 to 700 nm. In detail, when the near infrared ray absorption film has the transmissivity that is less than 20% with respect to the near infrared ray having the above-mentioned wavelength range and 60% or more with respect to the visible ray having the above-mentioned wavelength range, the near infrared ray absorption film may be preferably applied to the PDP filter.

Examples of the near infrared ray absorption coloring material that is frequently used for the PDP filter may include diimmonium-based, phthalocyanine-based, naphthalocyanine-based, dithiol-metal complexe-based, and cyanine-based compounds. However, there is no near infrared ray absorption substance that is capable of blocking the entire region of the wavelength ranging from of 820 to 1000 nm to 20% or less while only one substance is used.

Therefore, in the related art, at least two types of the near infrared ray absorption coloring materials are used while being mixed with each other in order to produce the near infrared ray absorption filter. That is, in the case of when one type of near infrared ray absorption coloring material is used, the near infrared wave that is generated from the PDP module is insufficiently blocked, causing the malfunction of remote controls of electronic peripheral devices.

Meanwhile, a process where an absorption wavelength of a diimmonium-based near infrared ray absorption coloring material is induced to shift to a short wavelength using a fluorine-based binder having a low refractive index (JP2003-268312) or a silicone-based adhesive agent (JP2005-062506) to produce a near infrared ray absorption film using a single coloring material is known. However, the above-mentioned process is problematic in that since compatibility to the near infrared ray absorption coloring material is poor in the case of when the binder or the adhesive agent is used, it is difficult to produce a transparent film after the film is produced and a change in transmissivity is undesirably significant before and after the test in a high temperature or high temperature and humidity condition.

### DISCLOSURE

### Technical Problem

The present inventors have conducted studies, resulting in the finding of a diimmonium-based compound that maximumly absorbs a near infrared ray, particularly the near infrared ray having a wavelength of 800 to 1200 nm, and maximumly transmits visible rays therethrough, using only one type of substance.

Therefore, an object of the present invention is to provide a near infrared ray absorption film that includes the diimmonium-based compound, and a plasma display panel having the same.

### Technical Solution

The present invention provides a near infrared ray absorption film for a plasma display panel filter. The near infrared ray absorption film includes a diimmonium-based compound of Formula 1, and a binder resin.

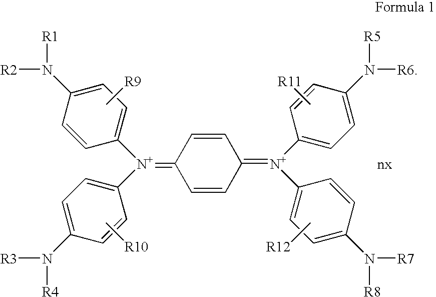

In Formula 1, amine groups substituted by R1 to R8 (—N—R1R2, —N—R3R4, —N—R5R6, and —N—R7R8) are identical or different, and electron withdrawing functional groups that are bonded to benzene rings so that charge distributions of the benzene rings are −0.104 or more,

R9 to R12 are respectively identical or different, and selected from the group consisting of a hydrogen atom, C₁ to C₆ alkyl groups containing a halogen atom, and C₆ to C₂₀ aryl groups,

n is 1 or 2, and

X is a divalent anion of an organic acid or an inorganic acid with the proviso that n is 1, and a monovalent anion of the organic acid or the inorganic acid with the proviso that n is 2.

Preferably, in Formula 1, R1 to R8 are respectively identical or different, and are C₁ to C₄ alkyl groups; a phenyl group; a nitro group; a thiol group; a carboxyl group; a thiocarboxyl group; C₁ to C₈ alkyl groups that are substituted by a group selected from the group consisting of a halogen atom, a nitro group, a thiol group, a carboxyl group, and a thiocarboxyl group; a phenyl group that is substituted by a group selected from the group consisting of a halogen atom, a nitro group, a thiol group, a carboxyl group, a thiocarboxyl group, and C₁ to C₄ alkyl groups substituted by a halogen atom; or C₁ to C₄ alkyl groups or phenyl groups that contain a group selected from the group consisting of an ether group, an ester group, a carbonyl group, an amide group, a thioether group, a sulfoxide group, and a sulfonyl group.

More preferably, in Formula 1, R1 to R8 are respectively identical or different, and are a methyl group; an ethyl group; a propyl group; —CH₂0CH₃; —CH₂COCH₃; —CH₂COOCH₃; —COCH(CH₃)₂; —CH₂NHCOCH₃; —SOCH₃; —SO₂CF₃; —SO₃CH₃; —CH₂SCH₃; —CH₂SOCH₃; —CH₂CH₂CH₂CF₃; —COCH(CH₃)₂; —COCH₃; —CH₂CH₂CCl₃; —CH₂(CH₂)₇CF₃; —CF₃; —CH₂CH₂CF₃; —COCH₃; —SO₃CH₃; —SO₂CF₃; —CH₂—SO—CH₃; —SO—CH₃; —CH₂—S—CH₃; —CH₂COOCH₃; —CH₂—O—CH₃; —CH₂NHCO—CH₃; —CH₂CH₂NO₂; —CH₂CH₂SH; —CH₂CH₂COOH; a phenyl group; or a phenyl group substituted by a group selected from the group consisting of —F, —Cl, —CH₂CF₃, —NO₂, —OCH₃, —COCH₃, —SOCH₃, —COOCH₃, —COOH, —SOOH, and —NHCOCH₃. However, R1 to R8 are not limited thereto.

### Advantageous Effects

A diimmonium-based compound according to the present invention is used as a near infrared ray absorption coloring material to produce a near infrared ray absorption film for a plasma display panel filter. Thus, it is possible to desirably absorb near infrared rays of 800 to 1200 nm using only the diimmonium-based compound without separate near infrared ray absorption to prevent the malfunction of remote controls of peripheral devices. Additionally, the near infrared ray absorption film that is produced using the diimmonium-based near infrared ray absorption coloring material according to the present invention has excellent durability at high temperature and at high temperature and humidity.

### DESCRIPTION OF DRAWINGS

FIG. 1 illustrates a near infrared wave that is generated from Xe used in a plasma display module;

FIG. 2 illustrates a change in HOMO level of a diimmonium-based compound according to electron withdrawing ability of a substituent group —N(R,R′) of Formula 1;

FIG. 3 illustrates a transmissivity spectrum of a near infrared ray absorption film that is produced in Example 1 and Example 2;

FIG. 4 illustrates a change in transmissivity spectrum of the near infrared ray absorption film that is produced in Example 1 before and after a test at the high temperature for 500 hours;

FIG. 5 illustrates a change in transmissivity spectrum of the near infrared ray absorption film that is produced in Example 1 before and after a test at the high temperature and humidity for 500 hours; and

FIG. 6 is a sectional view of a plasma display panel that is provided with the near infrared ray absorption film according to the present invention.

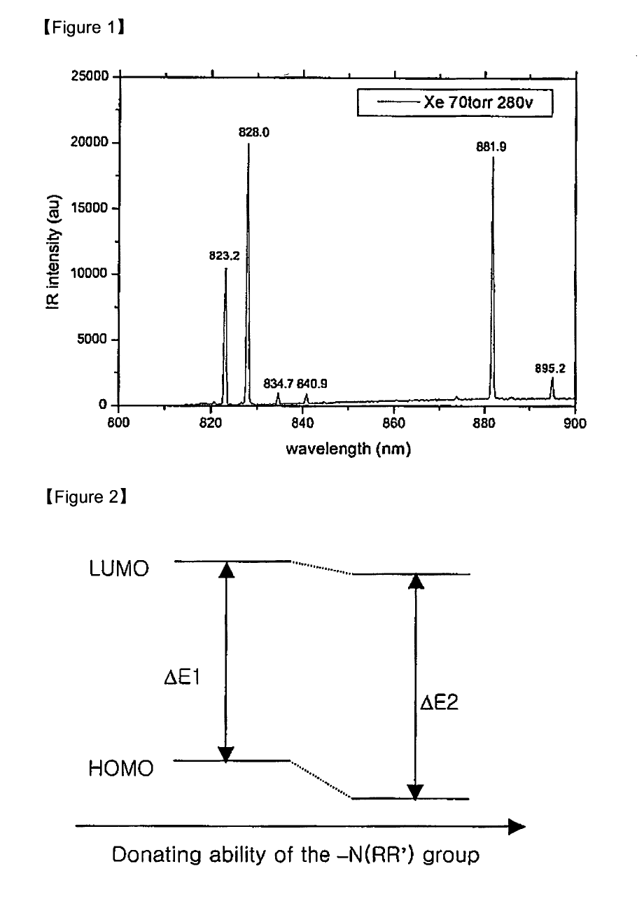

[148: a surface reflection control layer,

146: a neon cut layer(a color control layer including a neon cut film),

144: a glass,

142: an electromagnetic wave blocking film (EMI film),

140: a near infrared ray absorption layer (NIR film)]

### Best Mode

Hereinafter, the present invention will be described in detail.

A conventional diimmonium-based compound that is used as a near infrared ray absorption coloring material applied to a near infrared ray absorption film for a plasma display panel filter is problematic in that it is impossible to desirably absorb a near infrared ray having a low wavelength band. However, in the present invention, a diimmonium-based compound that has a predetermined substituent group to shift the maximum absorption wavelength to a shorter wavelength as compared to the conventional compound is used. Thus, it is possible to provide a near infrared ray absorption film capable of absorbing a near infrared ray having a wavelength of 800 to 1200 nm even though a single coloring material is used.

In detail, the shift of the maximum absorption wavelength of the diimmonium-based compound is significantly affected by an electron withdrawing ability of the amine groups substituted by R1 to R8 of Formula 1. In the diimmonium-based compound that has the structure such as Formula 1, if the electron withdrawing ability of amine groups bonded to four benzene rings, that is, —N(R,R′), is increased, a HOMO (highest occupied molecular orbital) energy level of the diimmonium-based compound is reduced, thus shifting the maximum absorption wavelength of the compound to the short wavelength (see FIG. 2). That is, it is preferable that the electron withdrawing ability of —N(R,R′) of the compound structure be increased in order to shift the maximum absorption wavelength of the diimmonium-based compound to the short wavelength. The electron withdrawing ability of the —N(R,R′) is increased as the electron withdrawing ability of R and R′ is increased.

The maximum absorption wavelength of the diimmonium-based compound having substituent groups that are considered to shift the maximum absorption wavelength of the diimmonium-based compound to the short wavelength, as the amine groups substituted by R1 to R8 of Formula 1, is calculated, and the calculated values are described in the following Table 1.

As described in the following Table 1, when R and R′ of the —N(R,R′) group are converted from a butyl group to an ethyl group, the maximum absorption wavelength of the diimmonium-based compound is shifted 13 nm toward the short wavelength on the basis of the —N[(CH₂)₃CH₃]₂ group. The reason is that the ethyl group is higher than the butyl group in terms of the electron withdrawing ability. Additionally, in the case of —N[(CH₂)₃CF₃]₂ and —N(CH₂CF₃)₂, the fluorine group is added to an end of the alkyl group to increase the electron withdrawing ability. Thus, the maximum absorption wavelengths of the diimmonium-based compounds having —N[(CH₂)₃CF₃]₂ and —N(CH₂CF₃)₂ are shifted in 15 nm and 163 nm, respectively, on the basis of the compound having the —N[(CH₂)₃CH₃]₂ group. In addition, in the case of —NHCOCH(CH₃)₂ and —N(COCH₃)₂ groups having the strong electron withdrawing ability, the maximum absorption wavelengths of the diimmonium-based compounds are shifted in 115 nm and 154 nm, respectively, toward the short wavelength on the basis of the —N[(CH₂)₃CH₃]₂ group. With respect to the calculation, optimization is performed using a DFT (Density Functional Theory). The calculation is performed using JINDO.

TABLE 1

| | —N[(CH₂)₃CH₃]₂ | —N[(CH₂)₃CF₃]₂ | —N(CH₂CH₃)₂ | —N(CH₂CF₃)₂ | —NHCOCH(CH₃)₂ | —N(COCH₃)₂ |
|---|---|---|---|---|---|---|
| calculated | 1224 | 1209 | 1211 | 1061 | 1109 | 1070 |
| λ max | | (15) | (13) | (163) | (115) | (154) |
| (Δ λmax) | | | | | | |

Accordingly, in the present invention, the substituent groups having electron withdrawing ability capable of shifting the maximum absorption wavelength of the diimmonium-based compound toward the short wavelength, as the amine groups substituted by R1 to R8 of Formula 1, are introduced. Thereby, even if only the diimmonium-based compound is used as the near infrared ray absorption coloring material, it is possible to produce the near infrared ray absorption film capable of desirably absorbing the near infrared ray.

The present invention is characterized by using, as the near infrared ray absorption coloring material, the diimmonium-based compound having substituent groups, as the amine groups substituted by R1 to R8 of Formula 1, that are bonded to the benzene rings so that charge distributions of the benzene rings are −0.104 or more, and preferably −0.08 or more. When a predetermined functional group is bonded to the benzene ring, the charge distribution of the benzene ring is proportional to the charge distribution of the benzene ring substituted by the amine group when the predetermined functional group is provided to R1 to R8 of Formula 1.

In the present invention, population analysis is performed to analyze the charge of the benzene ring bonded to the functional group. The analysis is performed using a Hirshfeld charge.

In detail, the calculated values of charge distribution of the benzene ring when the amine group substituted by R1 to R8 is bonded to the benzene ring are described in the following Table 2.

TABLE 2

| | Functional group | Benzene-X |
|---|---|---|
| 1 | —N(CH₂CH₂CH₂CH₃)₂ | −0.104 |
| 2 | —N(C₆H₅)₂ | −0.043 |
| 3 | —N(CH₂CH₂CH₂CF₃)₂ | −0.077 |
| 4 | —NHCOCH(CH₃)₂ | 0.012 |
| 5 | —N(COCH₃)₂ | 0.092 |
| 6 | —NH₂ | −0.075 |
| 7 | —N(CH₃)₂ | −0.084 |
| 8 | —N(CH₂CH₂CCl₃)₂ | −0.066 |
| 9 | —N(CH₂(CH₂)₇CF₃)₂ | −0.068 |
| 10 | —N(CF₃)₂ | 0.119 |
| 11 | —N(CH₂CH₂CF₃)₂ | −0.033 |
| 12 | —N(C₆H₄-p-F)₂ | 0.011 |
| 13 | —N(C₆H₄-p-Cl)₂ | 0.022 |
| 14 | —N(C₆H₄—CH₂CF₃)₂ | 0.037 |
| 15 | —N(CH₂COCH₃)₂ | −0.051 |
| 16 | —N(C₆H₄-p-COCH₃)₂ | 0.075 |
| 17 | —N(SO₃CH₃)₂ | 0.095 |
| 18 | —N(SO₂CF₃)₂ | 0.126 |
| 19 | —N(C₆H₄-p-SOCH₃)₂ | 0.045 |
| 20 | —N(CH₂—SO—CH₃)₂ | −0.031 |
| 21 | —N(SO—CH₃)₂ | −0.009 |
| 22 | —N(CH₂—S—CH₃)₂ | −0.061 |
| 23 | —N(CH₂COOCH₃)₂ | −0.055 |
| 24 | —N(C₆H₄-p-COOCH₃)₂ | 0.064 |
| 25 | —N(CH₂—O—CH₃)₂ | −0.039 |
| 26 | —N(C₆H₄-p-OCH₃)₂ | −0.018 |
| 27 | —N(CH₂NHCO—CH₃)₂ | −0.051 |
| 28 | —N(C₆H₄-p-NHCO—CH₃)₂ | −0.011 |
| 29 | —N(CH₂CH₂NO₂)₂ | −0.007 |
| 30 | —N(C₆H₄-p-NO₂)₂ | 0.099 |
| 31 | —N(CH₂CH₂SH)₂ | −0.040 |
| 32 | —N(CH₂CH₂COOH)₂ | −0.057 |
| 33 | —N(C₆H₄-p-COOH)₂ | 0.081 |
| 34 | —N(CH₂CH₂SOOH)₂ | −0.032 |
| 35 | —N(C₆H₄-p-SOOH)₂ | 0.060 |

As shown in the above-mentioned Table 2, in the case of when —N(CH₂CH₂CH₂CH₃)₂ is bonded to the benzene ring, the charge distribution of the benzene ring is −0.104. The present inventors have found the following fact. In the case of when the substituent group that is bonded to the benzene ring so that the charge distribution of the benzene ring that is −0.104 or more, is provided, as the amine group substituted by R1 to R8 of Formula 1, the maximum absorption wavelength of the total diimmonium-based compound is shifted to the short wavelength. The above-mentioned description is supported by Examples as described later. In the present invention, the substituent group that is bonded to the benzene ring so that the charge distribution of the benzene ring that is −0.08 or more, is preferably provided, as the amine group substituted by R1 to R8 of Formula 1, so that the maximum absorption wavelength of the total diimmonium-based compound is shifted 30 nm or more toward the short wavelength on the basis of the maximum absorption wavelength of a conventional coloring material, thereby the near infrared ray having the wavelength of 800 to 1200 nm is desirably absorbed.

In the present invention, the binder resin that is used to produce the near infrared ray absorption film is not limited as long as the binder resin is capable of being used in the art. Desirably, the binder resin has excellent transparency. In the present invention, it is preferable that the binder resin be a polymer resin having a refractive index of 1.45 to 1.55. Examples of the binder resin include, but are not limited to an aliphatic ester resin, an acryl-based resin, a melamine resin, an urethane resin, an aromatic ether resin, a polycarbonate resin, a polyvinyl-based resin, an aliphatic polyolefine resin, an aromatic polyolefine resin, a polyvinyl alcohol resin, a polyvinyl modified resin, and a copolymer resin thereof.

The near infrared ray absorption film according to the present invention may be produced using the above-mentioned diimmonium-based compound as the near infrared ray absorption coloring material through a process known in the art. Examples of the process include, but are not limited to, a process where the above-mentioned diimmonium-based compound and the binder resin are dissolved in an organic solvent and then applied on a substrate that is formed of a transparent resin film, a transparent resin plate, or transparent glass, using spin coating, bar coating, roll coating, or spraying. In the present invention, an additive such as a UV absorbing agent or a plasticizer that is typically used to form a resin may be added during the production of the near infrared ray absorption film.

Furthermore, in the present invention, an organic coloring material for color control having the maximum absorption wavelength in a visible range, for example, 400 to 750 nm, may be further added to change the tone of the filter. Materials known in the art can be used as the organic coloring material for color control. Examples of the organic coloring material for color control include polymethine-based dyes or porphyrin-based dyes having maximum absorption wavelength of 570-600nm that act as neon cut dyes.

Examples of the polymethine-based dye include the compounds of below Formulas 2 to 4.

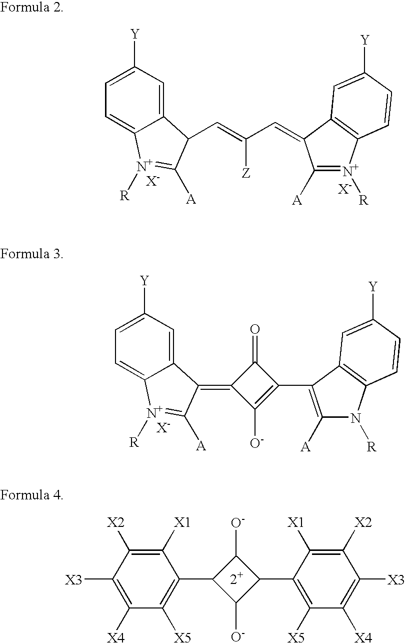

In Formulas 2 and 3,

R is, respectively, a hydrogen atom or C₁-C₁₆ aliphatic hydrocarbon groups;

A is, respectively, a hydrogen atom, C₁-C₈ alkyl groups or C₆-C₃₀ aryl groups;

Y is, respectively, a halogen atom, a nitro group, a cyanine group, a sulfonic acid group, a sulfonate group, a sulfonyl group, a carboxylic group, C₂-C₈ alkoxycarbonyl groups, a phenoxycarbonyl group, a carboxylate group, C₁-C₈ alkyl groups, C₁-C₈ alkoxy groups or C₆-C₃₀ aryl groups;

Z is a hydrogen atom, a halogen atom, a cyano group, C₁-C₈ alkyl groups or C₆-C₁₀ aryl groups; and

X− is a halogen anion such a chloric anion, a bromic anion, an iodic anion and a fluoric anion; a perhalogen acid anion such as a perchloric acid anion, a perboromic acid anion and a periodic acid anion; a fluoro-complex anion such as a boron tetrafluoride anion, an antimony hexafluoride anion and a phophorus hexafluoride; an alkyl sulfate anion such a methyl sulfate anion and an ethyl sulfate anion; a sulfonate anion such a p-toluene sulfonate anon and a p-chlorobenzene sulfonate anion.

In Formula 4, X1˜X5 are respectively a hydrogen atom, a hydroxy group, C₁-C₁₆ alkyl groups, an amine group unsubstituted or substituted by C₁-C₁₆ alkyl groups, an alkoxy group, an aryl group, an aryloxy group or a halogen group.

Examples of the porphyrin-based dye include the compounds of below Formula 5.

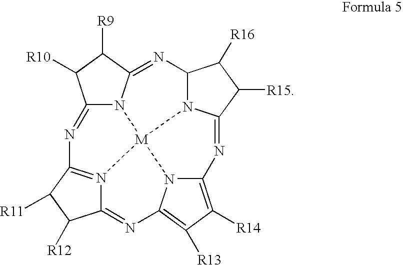

In Formula 5, R9 to R16 are, respectively, a hydrogen atom, a halogen atom, substituted or unsubstituted C₁-C₁₆ alkyl groups, a substituted or unsubstituted alkoxy group, a substituted or unsubstituted phenyl group, a substituted or unsubstituted aryloxy group, an alkoxy group substituted by a fluorine, or a 5-membered ring having at least one substituted or unsubstituted nitrogen atom; M is a metal having a divalent, tirvalent or tetravalent ligand, wherein the above groups may be substituted by a hydrogen atom, an oxygen atom, a halogen atom, a hydroxy group or an alkoxy group.

The near infrared ray absorption film according to the present invention has transmissivity of 60% or more at 430 nm, 550 nm, and 630 nm of the visible range, and transmissivity of 20% or less at 820 nm, 850 nm, and 950 nm of the near infrared ray range.

Additionally, the present invention provides a plasma display panel filter that is provided with the near infrared ray absorption film and a plasma display panel.

The plasma display panel filter according to the present invention may further include an electromagnetic wave blocking layer, a neon cut layer, or a surface reflection control layer, in addition to the near infrared ray absorption film according to the present invention. FIG. 6 illustrates a sectional view of the plasma display panel provided with the near infrared ray absorption film according to the present invention.

### Mode for Invention

A better understanding of the present invention may be obtained in light of the following Examples and Examples which are set forth to illustrate, but are not to be construed to limit the present invention.

### EXAMPLE 1

### Production of the Near Infrared Ray Absorption Film

1) Production of a Coating Solution

0.720 g of a diimmonium-based coloring material of Formula 1 (R1 to R8 are each —CH₂CH₂CH₂CF₃ in Formula 1, and the charge distribution of the benzene ring: −0.077) was added to 26 wt % of a solution (100 g) where 26 g of polymethylmethacrylate (PMMA) was dissolved in 74 g of methyl ethyl ketone (MEK), and then mixed with each other for 2 hours. The resulting solution was defoamed for 1 hour.

2) Coating

Transparent PET having a thickness of 100 was coated with the coating solution using bar coating. In connection with this, the coating was performed so that transmissivity was 2.0% at 950 nm. After the drying, the thickness of the coating layer was 15.

### EXAMPLE 2

The procedure of Example 1 was repeated except that the diimmonium-based absorption coloring material (R1 to R8 are each —CH₂CH₂CH₂CH₃ in Formula 1, and the charge distribution of the benzene ring: −0.104) was used as the diimmonium-based near infrared ray absorption coloring material.

### EXPERIMENTAL EXAMPLE 1

### Evaluation of Transmissivity of the Near Infrared Ray Absorption Film at the Visible Range and The Near Infrared Ray Region

The transmissivity of the PET transparent substrate was divided by the measured transmissivity to evaluate the transmissivity of only the coating layer. The transmissivity of the near infrared ray was evaluated at the wavelength of 820 nm, 850 nm, and 950 nm, and evaluation was performed at 430 nm, 550 nm, and 630 nm in the case of the visible range.

The transmissivities that were measured in Example 1 and Example 2 are described in the following Table 3.

TABLE 3

| | Visible range | | | Near infrared ray range | | |
|---|---|---|---|---|---|---|
| | 430 nm | 550 nm | 630 nm | 820 nm | 850 nm | 950 nm |
| Example 1(%) | 79.9 | 90.5 | 82.1 | 15.9 | 6.9 | 2.0 |
| Example 2(%) | 80.1 | 89.5 | 87.6 | 33.3 | 19.4 | 2.0 |
| Δt (Tₐ-T_{b}) | 0.2 | −1.0 | 5.5 | 17.4 | 12.5 | 0 |

As shown in the above-mentioned Table 3, an experiment was performed while the transmissivity at the wavelength of 950 nm corresponding to the near infrared ray range was fixed to 2.0%. As a result, an insignificant difference was found between Example 1 and Example 2 in transmissivity in the visible range (430 to 700 nm). However, in the near infrared ray range, the near infrared ray absorption film of Example 1 showed an improved effect of 17.5% and 12.5% in the near infrared ray blocking effect at 820 nm and 850 nm, respectively, as compared to that of Example 2, due to difference in the electron withdrawing ability of the substituent groups. Transmissivity spectra of the near infrared ray absorption film that was produced in Example 1 and Example 2 are shown in FIG. 3.

### EXPERIMENTAL EXAMPLE 2

### Evaluation of Durability

The durability was evaluated using a change in transmissivity and a change in concentration of the coloring material before and after the near infrared ray absorption film that was produced in Example 1 was stored in a chamber at a high temperature (80° C.) and a high temperature and humidity (60° C., relative humidity of 90%). The change in concentration of the coloring material was calculated using the following Equation 1.

$$Δ C ( \% ) = ( \frac{log {T}_{m}}{log {T}_{0}} - 1 ) \times 100. \qquad Equation 1$$

※ΔC: Change in concentration of the coloring material,

T₀: Transmissivity before the near infrared ray absorption film is stored in the chambers at the high temperature (80° C.) and at the high temperature and humidity (60° C., relative humidity of 90%), and

Tₘ: Transmissivity after the near infrared ray absorption film is stored in the chambers at the high temperature (80° C.) and at the high temperature and humidity (60° C., relative humidity of 90%).

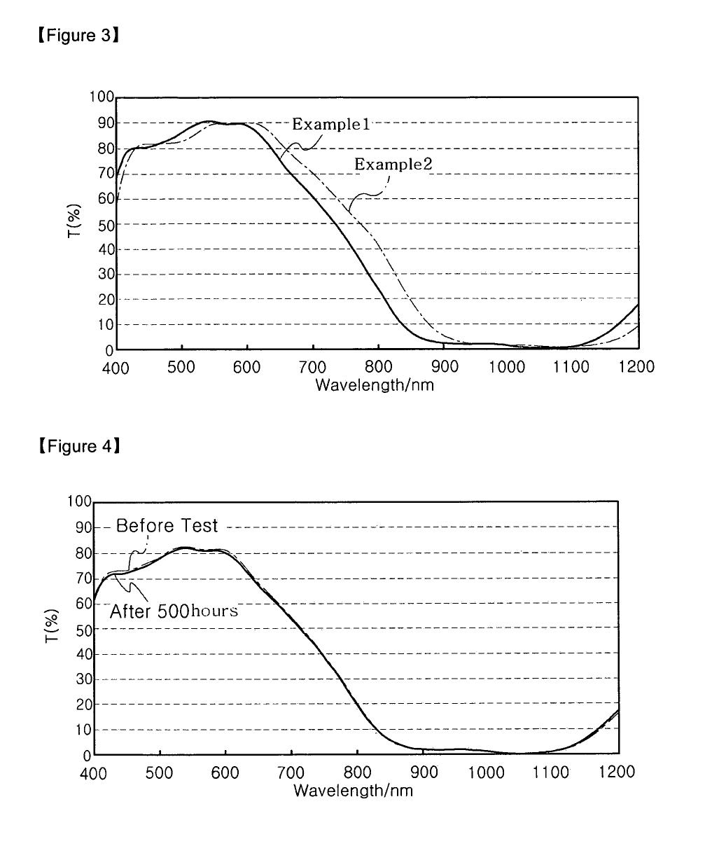

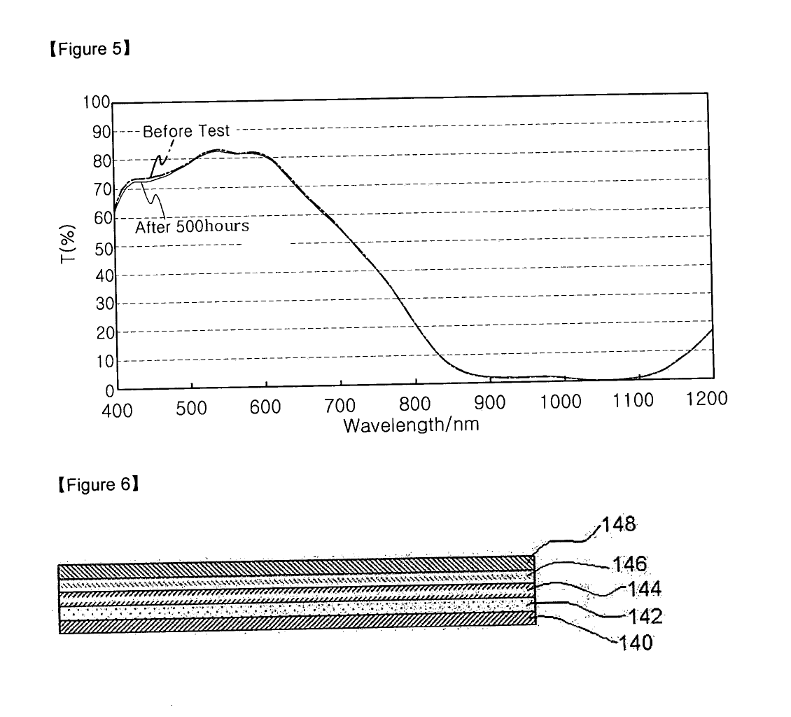

The durability was evaluated at 820 nm, 850 nm, and 950 nm in the case of the near infrared ray range and at 430 nm, 550 nm, and 630 nm in the case of the visible range. The evaluation results of the durability are described in the following Tables 4 and 5. Additionally, the change in transmissivity spectrum of the near infrared ray absorption film that is produced in Example 1 before and after the test at the high temperature for 500 hours and before and after the test at the high temperature and humidity for 500 hours is shown in FIGS. 4 and 5.

TABLE 4
Change in transmissivity and transmission color coordinate of the near infrared ray absorption
film that is produced in Example 1 before and after the test at high temperature for 500 hours

| | | | | | | | Transmission | | |
|---|---|---|---|---|---|---|---|---|---|
| | | | | | | | color (xy) | | |
| | 430 nm | 550 nm | 630 nm | 820 nm | 850 nm | 950 nm | x | y | Δxy |
| Transmissivity | 80.3 | 90.7 | 83.2 | 14.8 | 6.4 | 1.9 | 0.3361 | 0.3462 | 0.0007 |
| before test(%) | | | | | | | | | |
| Transmissivity | 79.1 | 90.2 | 82.4 | 14.4 | 6.4 | 2.1 | 0.3361 | 0.3469 | |
| after test(%) | | | | | | | | | |
| [symbol] Δ t(T₀-Tₘ)(%) | 1.2 | 0.5 | 0.8 | 0.5 | 0.0 | −0.2 | | | |
| Change in concentration | 6.9 | 6.1 | 5.6 | 1.8 | 0.0 | −1.4 | | | |
| of coloring material (%) | | | | | | | | | |

TABLE 5
Change in transmissivity and transmission color coordinate of the near infrared ray absorption film that
is produced in Example 1 before and after the test at high temperature and humidity for 500 hours

| | | | | | | | Transmission | | |
|---|---|---|---|---|---|---|---|---|---|
| | | | | | | | color (xy) | | |
| | 430 nm | 550 nm | 630 nm | 820 nm | 850 nm | 950 nm | x | y | Δxy |
| Transmissivity | 80.8 | 90.9 | 83.6 | 15.7 | 7.1 | 2.2 | 0.3360 | 0.3458 | 0.0011 |
| before test(%) | | | | | | | | | |
| Transmissivity | 79.4 | 90.5 | 83.0 | 15.7 | 7.2 | 2.2 | 0.3364 | 0.3468 | |
| after test(%) | | | | | | | | | |
| [symbol] Δ t(T₀-Tₘ)(%) | 1.3 | 0.5 | 0.6 | 0.0 | −0.1 | 0.0 | | | |
| Change in concentration | 7.8 | 5.5 | 4.2 | 0.0 | −0.6 | −0.4 | | | |
| of coloring material (%) | | | | | | | | | |

As shown in Tables 4 and 5, in the case of the visible range (430 to 700 nm), the change in transmissivity of the coloring material and the change in concentration of the coloring material of the near infrared ray absorption film according to the present invention were 1.5% or less and 10% or less before and after the test at the high temperature for 500 hours and before and after the test at the high temperature and humidity for 500 hours. However, there were no change in transmissivity of the coloring material and in concentration of the coloring material in the case of the near infrared ray range.

Accordingly, it can be seen that the near infrared ray absorption film produced using the diimmonium-based near infrared ray absorption coloring material according to the present invention has excellent durability at high temperature and at high temperature and humidity.

1. A near infrared ray absorption film for a plasma display panel filter comprising:
a diimmonium-based compound of Formula 1; and
a binder resin, 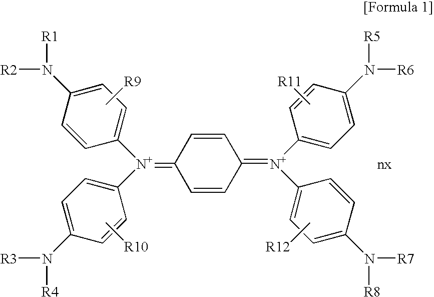
wherein amine groups substituted by R1 to R8 (—N—R1R2, —N—R3R4, —N—R5R6, and —N—R7R8) are identical or different, and electron withdrawing functional groups that are bonded to benzene rings so that charge distributions of the benzene rings are −0.104 or more,
R9 to R12 are respectively identical or different, and selected from the group consisting of a hydrogen atom, C₁to C₆ alkyl groups containing a halogen atom and C₆ to C₂₀ aryl groups,
n is 1 or 2, and
X is a divalent anion of an organic acid or an inorganic acid with the proviso that n is 1, and a monovalent anion of the organic acid or the inorganic acid with the proviso that n is 2.

2. The near infrared ray absorption film as set forth in claim 1, wherein the amine groups substituted by R1 to R8 (—N—R1 R2, —N—R3R4, —N—R5R6, and —N—R7R8) are functional groups that have electron withdrawing ability and are bonded to the benzene rings so that the charge distributions of the benzene rings are −0.08 or more.

3. The near infrared ray absorption film as set forth in claim 1, wherein R1 to R8 are respectively identical or different, and are C₁ to C₄ alkyl groups; a phenyl group; a nitro group; a thiol group; a carboxyl group; a thiocarboxyl group; C₁ to C₈ alkyl groups that are substituted by a group selected from the group consisting of a halogen atom, a nitro group, a thiol group, a carboxyl group, and a thiocarboxyl group; a phenyl group that is substituted by a group selected from the group consisting of a halogen atom, a nitro group, a thiol group, a carboxyl group, a thiocarboxyl group, and C₁ to C₄ alkyl groups substituted by a halogen atom; or C₁ to C₄ alkyl groups or phenyl groups that contain a group selected from the group consisting of an ether group, an ester group, a carbonyl group, an amide group, a thioether group, a sulfoxide group, and a sulfonyl group.

4. The near infrared ray absorption film as set forth in claim 1, wherein R1 to R8 are respectively identical or different, and are a methyl group; an ethyl group; a propyl group; —CH₂OCH₃; —CH₂COCH₃; —CH₂COOCH₃; —COCH(CH₃)₂; —CH₂NHCOCH₃; —SOCH₃; —SO₂CF₃; —SO₃CH₃; —CH₂SCH₃; —CH₂SOCH₃; —CH₂CH₂CH₂CF₃; —COCH(CH₃)₂; —COCH₃; —CH₂CH₂CCl₃; —CH₂(CH₂)₇CF₃; —CF₃; —CH₂CH₂CF₃; —COCH₃; —SO₃CH₃; —SO₂CF₃; —CH₂—SO—CH₃; —SO—CH₃; —CH₂—S—CH₃; —CH₂COOCH₃; —CH₂—O—CH₃; —CH₂NHCO—CH₃; —CH₂CH₂NO₂; —CH₂CH₂SH; —CH₂CH₂COOH; a phenyl group; or a phenyl group substituted by a group selected from the group consisting of —F, —Cl, —CH₂CF₃, —NO₂, —OCH₃, —COCH₃, —SOCH₃, —COOCH₃, —COOH, —SOOH, and —NHCOCH₃.

5. The near infrared ray absorption film as set forth in claim 1, wherein the binder resin is selected from the group consisting of an aliphatic ester resin, an acryl-based resin, a melamine resin, an urethane resin, an aromatic ether resin, a polycarbonate resin, a polyvinyl-based resin, an aliphatic polyolefine resin, an aromatic polyolefine resin, a polyvinyl alcohol resin, a polyvinyl modified resin, and a copolymer resin thereof.

6. The near infrared ray absorption film as set forth in claim 1, wherein the near infrared ray absorption film has transmissivity of 60% or more at 430 nm, 550 nm, and 630 nm of a visible range, and transmissivity of 20% or less at 820 nm, 850 nm, and 950 nm of a near infrared ray range.

7. The near infrared ray absorption film as set forth in claim 1, further comprising an organic coloring material for color control having a maximum absorption wavelength in a visible range of 400 to 750 nm.

8. A plasma display panel filter that is provided with the near infrared ray absorption film of claim 1.

9. The plasma display panel filter as set forth in claim 8, further comprising one or more layers of an electromagnetic wave blocking layer, a neon cut layer, and a surface reflection control layer.

10. A plasma display panel that is provided with the plasma display panel filter of claim 8.
